(19) United States
(12) Patent Application Publication
(10) Pub. No.: US 2013/0244585 A1
(43) Pub. Date: Sep. 19, 2013

(54) Transmission Power Control Negotiation Method and Wireless Communication System Using the Same

(71) Applicants: Chao-Lin Chen, Hsinchu City (TW); Yuan-Hwa Li, Hsinchu City (TW); Chun-Hsien Pan, Kaohsiung City (TW)

(72) Inventors: Chao-Lin Chen, Hsinchu City (TW); Yuan-Hwa Li, Hsinchu City (TW); Chun-Hsien Pan, Kaohsiung City (TW)

(21) Appl. No.: 13/419,446

(22) Filed: Mar. 14, 2012

(51) Int. Cl. H04W 52/22

(52) U.S. Cl. 455/69

(57) ABSTRACT

The present invention discloses a transmission power control negotiation method for a communication system. The communication system includes a first transceiver and a second transceiver. The transmission power control negotiation method includes the first transceiver transmitting first adjustment signal to the second transceiver with a first transmission power; the second transceiver analyzing the first adjustment signal and sending negotiation messages for the first transceiver to adjust the first transmission power; and the first transceiver transmitting following signals with the first transmission power.

### BACKGROUND

The present invention relates to a transmission power control negotiation method and wireless communication system using the same, and more particularly, to a transmission power control negotiation method and wireless communication system using the same capable of negotiating with a transceiver in a receiving end, to determine an adequate transmission power which reduces unnecessary power consumption as most in a short cable case and avoids an interoperability issue in a long cable case.

In Ethernet, the transmission amplitude is defined to fixed value, i.e. a default transmission power, with small variance. In such a situation, when a local device transmits signals to a remote device via a cable, the transmission amplitude is usually overqualified in a short cable case and is unqualified in a long cable case. As a result, unnecessary transmission power consumption might occur in the short cable case and an interoperability issue might happen in the long cable case, e.g. power of transmitted signal is too low after a long cable and thus signal quality is too bad for the remote device.

Therefore, a conventional guess method is applied in the local device to reduce power consumption in the short cable case. In detail, the local device adopts cable estimator to detect a cable length first, and then adjusts transmission amplitude based on a cable length index and predefined lookup tables. In such a situation, excellent cable length estimator and lookup tables are necessary for properly adjusting transmission amplitude to reduce power consumption.

However, since the local device estimates the cable length by itself, the estimated cable length may not be reliable due to unideal factors. Besides, since the adjusted transmission amplitude is not confirmed by the remote device, there is still an interoperability issue. Therefore, the conventional guess method is conservative in reducing transmission power level to ensure the remote device receives signals with enough signal quality, and thus the conventional guess method can not reduce unnecessary power consumption at most. Therefore, there is a need for improvement.

### SUMMARY

It is therefore an objective of the present invention to provide a transmission power control negotiation method and wireless communication system using the same capable of negotiating with a transceiver in a receiving end, to determine an adequate transmission power which reduces unnecessary power consumption as most in a short cable case and avoids interoperability issue in a long cable case.

The present invention discloses a transmission power control negotiation method for a communication system. The communication system includes a first transceiver and a second transceiver. The transmission power control negotiation method includes the first transceiver transmitting first adjustment signal to the second transceiver with a first transmission power; the second transceiver analyzing the first adjustment signal and sending negotiation messages for the first transceiver to adjust the first transmission power; and the first transceiver transmitting following signals with the first transmission power.

The present invention further discloses a wireless communication system. The wireless communication system includes a first transceiver including a first transmission power control circuit, including a first request circuit and a first response circuit; and a second transceiver including a second transmission power control circuit, including a second request circuit and a second response circuit; wherein the first transceiver and the second transceiver perform the above transmission power control negotiation method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a communication system according to an embodiment of the present invention.

FIG. 1B is a schematic diagram of a transmission power control negotiation process for the communication system shown in FIG. 1A according to an embodiment of the present invention.

FIG. 2A is a schematic diagram of operations of one transceiver indicating another transceiver shown in FIG. 1A to start adjusting transmission power according to an embodiment of the present invention.

FIG. 2B is a schematic diagram of operations of one transceiver indicating another transceiver that the one transceiver shown in FIG. 1A starts to adjust itself transmission power according to an embodiment of the present invention.

FIG. 3-6 are schematic diagrams of operations of request circuits, and response circuits shown in FIG. 1A under different scenarios.

### DETAILED DESCRIPTION

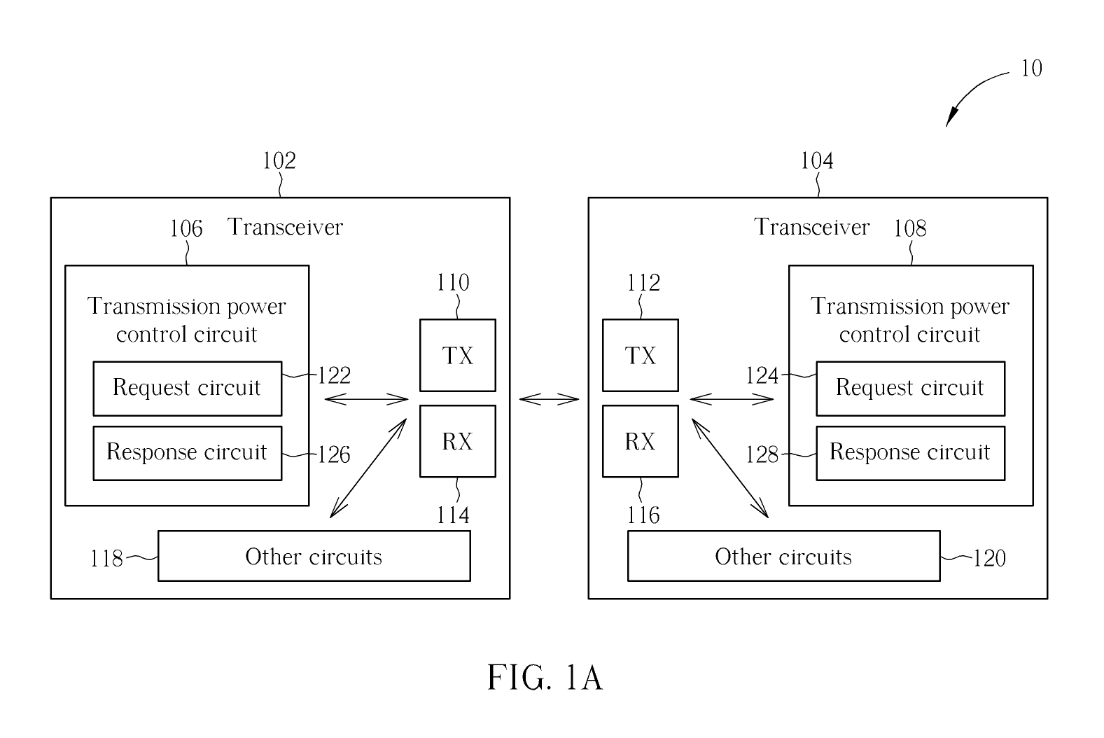

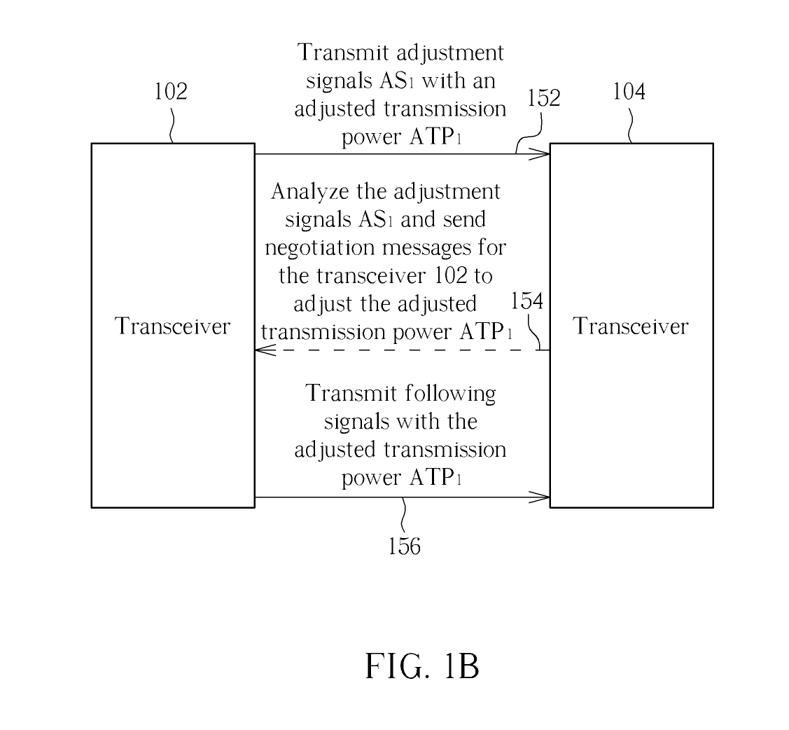

Please refer to FIG. 1A and FIG. 1B. FIG. 1A is a schematic diagram of a communication system 10 according to an embodiment of the present invention, and FIG. 1B is a schematic diagram of a transmission power control negotiation process 15 for the communication system 10 according to an embodiment of the present invention. As shown in FIG. 1A, the communication system 10 is preferably an Ethernet communication system, and includes transceivers 102, 104. The transceivers 102, 104 are linked by a wire or cable, and include transmission power control circuits 106, 108, transmitters (TXs) 110, 112, receivers (RXs) 114, 116, other circuits 118, 120, respectively, wherein the transmission power control circuits 106, 108 include request circuits 122, 124, and response circuits 126, 128. Operations of the transmitters 110, 112, the receivers 114, 116, and the other circuits 118, 120 for realizing other functions of the transceivers 102, 104 are similar to those of conventional transceivers, and are known by those skilled in the art. The transceivers 102, 104 further include the transmission power control circuits 106, 108, and thus can perform the transmission power control negotiation process 15 shown in FIG. 1B. The transmission power control negotiation process 15 includes the following steps:

Step 152: The transceiver 102 transmits adjustment signals AS₁ to the transceiver 104 with an adjusted transmission power ATP₁.

Step 154: The transceiver 104 analyzes the adjustment signals AS₁ and sends negotiation messages for the transceiver 102 to adjust the adjusted transmission power ATP₁.

Step 156: The transceiver 102 transmits following signals with the adjusted transmission power ATP₁.

According to the transmission power control negotiation process 15, when the transceiver 102 starts to adjust its transmission power (e.g. passively requested by the transceiver 104, or actively), the transceiver 102 (a transmitting end) transmits adjustment signals AS₁ to the transceiver 104 (a receiving end) with an adjusted transmission power ATP₁ which is different from a default transmission power. Then, after analyzing the adjustment signals AS₁, the transceiver 104 sends negotiation messages for the transceiver 102 to adjust the adjusted transmission power ATP₁, wherein the negotiation messages can be request messages which indicate the transceiver 102 to increase or decrease the adjusted transmission power ATP₁, acknowledgements for the adjustment signals AS₁ which the transceiver 102 can adjust the adjusted transmission power ATP₁ accordingly, or end messages which indicate the adjusted transmission power ATP₁ is adequate. Afterwards, after adjusting transmission power according to the negotiation messages, the transceiver 102 can transmit following signals with the adjusted transmission power ATP₁. Under such a situation, since the transceiver 102 derives the final adjusted transmission power ATP₁ by negotiating with the transceiver 104, the final adjusted transmission power ATP₁ is acceptable to the transceiver 104. As a result, the present invention can determine the adequate adjusted transmission power ATP₁ which reduces unnecessary power consumption as most in a short cable case and avoids an interoperability issue in a long cable case.

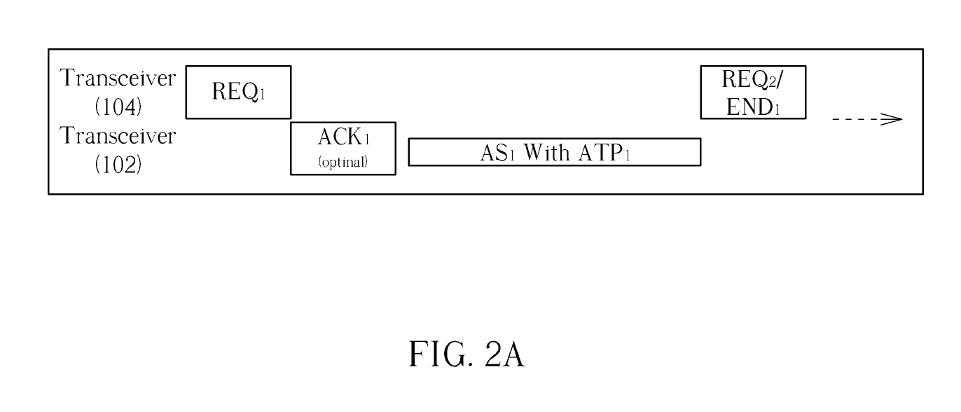

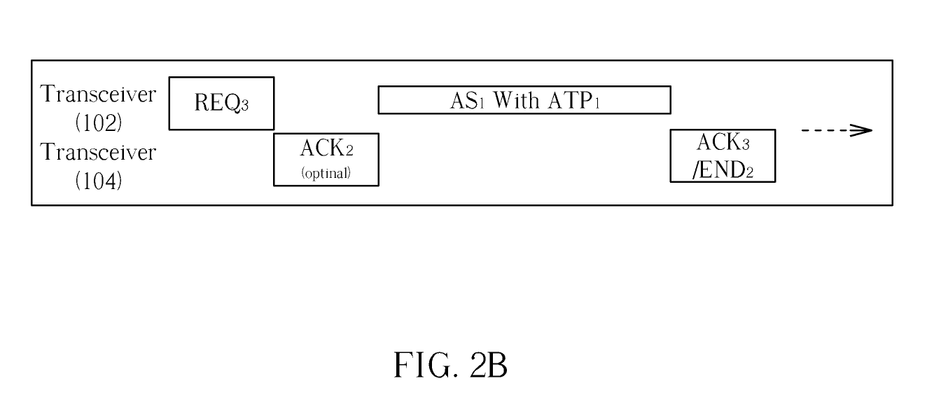

In detail, please refer to FIG. 2A and FIG. 2B. FIG. 2A is a schematic diagram of operations of the transceiver 104 indicating the transceiver 102 to start adjusting transmission power according to an embodiment of the present invention, and FIG. 2B is a schematic diagram of operations of the transceiver 102 indicating the transceiver 104 that the transceiver 102 starts to adjust its transmission power according to an embodiment of the present invention. In other words, there are two forms of initiating the transmission power control negotiation process 15. One is passively initiated by one transceiver to adjust transmission power of another transceiver as shown in FIG. 2A, i.e. the transceiver 104 adjust the transceiver 102, and another is actively initiated by one transceiver to adjust itself transmission power as shown in FIG. 2B, i.e. the transceiver 102 adjust itself.

As shown in FIG. 2A, when the transceiver 104 intends to adjust transmission power of the transceiver 102, the transceiver 104 sends a request message REQ₁ to indicate the transceiver 102 to start adjusting transmission power. After receiving the request message REQ₁, the transceiver 102 can optionally replies an acknowledgement ACK₁ for the request message REQ₁ and adopts the adjusted transmission power ATP₁ to transmit the adjustment signals AS₁, wherein the adjusted transmission power ATP₁ is different from the default transmission power and can be indicated by the request message REQ₁ or chosen by the transceiver 102. Then, after receiving and analyzing the adjustment signals AS₁, the transceiver 104 sends a request message REQ₂ to indicate the transceiver 102 to increase the adjusted transmission power ATP₁ if the adjustment signals AS₁ are unqualified (i.e. signal quality is not enough) or to decrease the adjusted transmission power ATP₁ if the adjustment signals AS₁ are overqualified (i.e. unnecessary power consumption).

Under such a situation, the transceiver 104 can repeat sending several request messages REQ₂ to indicate the transceiver 102 to adjust the adjusted transmission power ATP₁ until the adjustment signals AS₁ are not overqualified or unqualified, and then the transceiver 104 optionally sends an end message END₁ to indicate the adjusted transmission power ATP₁ is adequate if the adjustment signals AS₁ are not overqualified or unqualified and the transceiver 104 finished transmission power adjustment of its part. Then, when the transceiver 102 receives the end message END₁ or does not receive the request message REQ₂ for a long time (i.e. the transceiver 104 does not optionally send the end message END₁), the transceiver 102 finishes transmission power adjustment of its part and transmits following signals with the adjusted transmission power ATP₁. Under such a situation, the transceiver 104 can ask the transceiver 102 to adjust transmission power of the transceiver 102 to an adequate level, and the transceiver 102 can operate accordingly. As a result, the transceiver 102 can reduce unnecessary power consumption as most in a short cable case and avoids an interoperability issue in a long cable case when transmitting signals to the transceiver 104.

Noticeably, other than indicating the transceiver 102 to increase or decrease the adjusted transmission power ATP₁, the request message REQ₂ can further indicate the transceiver 102 to increase or decrease the adjusted transmission power ATP₁ by a desired power level. Besides, when the transceiver 102 receives the request message REQ₂ and then increases or decreases the adjusted transmission power ATP₁ to a largest available power or a smallest available power, the transceiver 102 can optionally send a MAX LEVEL DONE message or a MIN LEVEL DONE message to inform the transceiver 104, such that the transceiver 104 can finish adjusting transmission power of the transceiver 102 accordingly.

On the other hand, as shown in FIG. 2B, when the transceiver 102 intends to adjust itself transmission power, the transceiver 102 sends a request message REQ₃ to indicate the transceiver 104 that the transceiver 102 starts to adjust itself transmission power. After receiving the request message REQ₃, the transceiver 104 can optionally reply an acknowledgement ACK₂ for the request message REQ₃. After optionally receiving the acknowledgement ACK₂, the transceiver 102 adopts the adjusted transmission power ATP₁ to transmit the adjustment signals AS₁, wherein the adjusted transmission power ATP₁ is different from the default transmission power and is chosen by the transceiver 102. Then, after receiving and analyzing the adjustment signals AS₁, the transceiver 104 sends an acknowledgement ACK₃ for the adjustment signals AS₁ if the adjustment signals AS₁ are not unqualified (i.e. signal quality is good enough, but may be overqualified)

Under such a situation, when the transceiver 102 receives the acknowledgement ACK₃ for the previous adjustment signals AS₁, in order to reduce power consumption at most, the transceiver 102 can further lower the adjusted transmission power ATP₁ to transmit the adjustment signals AS₁, and the transceiver 104 can keep sending the acknowledgement ACK₃ for the adjustment signals AS₁ until the adjustment signals AS₁ are unqualified. During the above operations, the transceiver 104 can optionally send an end message END₂ to indicate the adjusted transmission power ATP₁ is adequate if the adjustment signals AS₁ are not overqualified or unqualified. Therefore, when the transceiver 102 receives the end message END₂, the transceiver 102 finishes transmission power adjustment of its part and transmits following signals with the adjusted transmission power ATP₁; otherwise, when the transceiver 102 does not receive the acknowledgement ACK₃ for a long time (i.e. the transceiver 104 does not optionally send the end message END₂), the transceiver 102 adjusts the adjusted transmission power ATP₁ as a default transmission power (e.g. not receiving any the acknowledgement ACK₃) or a adjusted transmission power ATP₂ with which the transceiver 102 transmits adjustment signals AS₂ and receives an acknowledgement ACK₄ for the adjustment signals AS₂, e.g. the lowest adjusted transmission power ATP₁ corresponding to the last received acknowledgement ACK₃. Then, the transceiver 102 finishes transmission power adjustment of its part and transmits following signals with the adjusted transmission power ATP₁, i.e. the default transmission power or the adjusted transmission power ATP₂.

Under such a situation, the transceiver 102 can notify the transceiver 104 that the transceiver 102 will adjust itself transmission power, and thus the transceiver 104 can know transmission power adjustment occurs and analyze the adjustment signals AS₁ without accidentally discarding the adjustment signals AS₁ with less good signal quality. Then, the transceiver 102 can adjust itself transmission power to an adequate level according to receiving status of the acknowledgement ACK₃. As a result, the transceiver 102 can reduce unnecessary power consumption as most in a short cable case and avoids an interoperability issue in a long cable case when transmitting signals to the transceiver 104.

Noticeably, the spirit of the present invention is that one transceiver can analyze adjustment signals with adjusted transmission power and send messages for another transceiver to adjust the adjusted transmission power, to reduce unnecessary power consumption as most in a short cable case and avoid an interoperability issue in a long cable case. Those skilled in the art should make modifications or alterations accordingly. For example, the above messages can be implemented by Fast Link Pulse (FLP) in auto-negotiation flow, undefined Physical Coding Sublayer (PCS) coding or Medium Access Control (MAC) protocol, and the communication system 10 can be other communication systems other than an Ethernet communication system.

Besides, the above embodiment illustrates an asynchronous transmission power adjustment, i.e. only one transceiver adjusts transmission power at a time. However, in the asynchronous transmission power adjustment, after one transceiver finishes adjusting transmission power, another transceiver can start adjusting transmission power, which requires long adjustment time.

Therefore, in other embodiments, in order to reduce adjustment time, synchronous transmission power adjustment is performed as well, i.e. two transceivers simultaneously adjust transmission power. In other words, during the transmission power control negotiation process 15, the transceiver 104 (a transmitting end) can also transmit adjustment signals AS₃ to the transceiver 102 (a receiving end) with an adjusted transmission power ATP₃ which is different from the default transmission power. Then, after analyzing the adjustment signals AS₃, the transceiver 102 sends negotiation messages for the transceiver 104 to adjust the adjusted transmission power ATP₃, wherein the negotiation messages can be request messages which indicate the transceiver 104 to increase or decrease the adjusted transmission power ATP₃, acknowledgements for the adjustment signals AS₃ which the transceiver 104 can adjust the adjusted transmission power ATP₁ accordingly, or end messages which indicate the adjusted transmission power ATP₃ is adequate. Afterwards, after adjusting transmission power according to the negotiation messages, the transceiver 104 can transmit following signals with the adjusted transmission power ATP₃. As a result, the transceivers 102, 104 can simultaneously adjust transmission power, to reduce adjustment time.

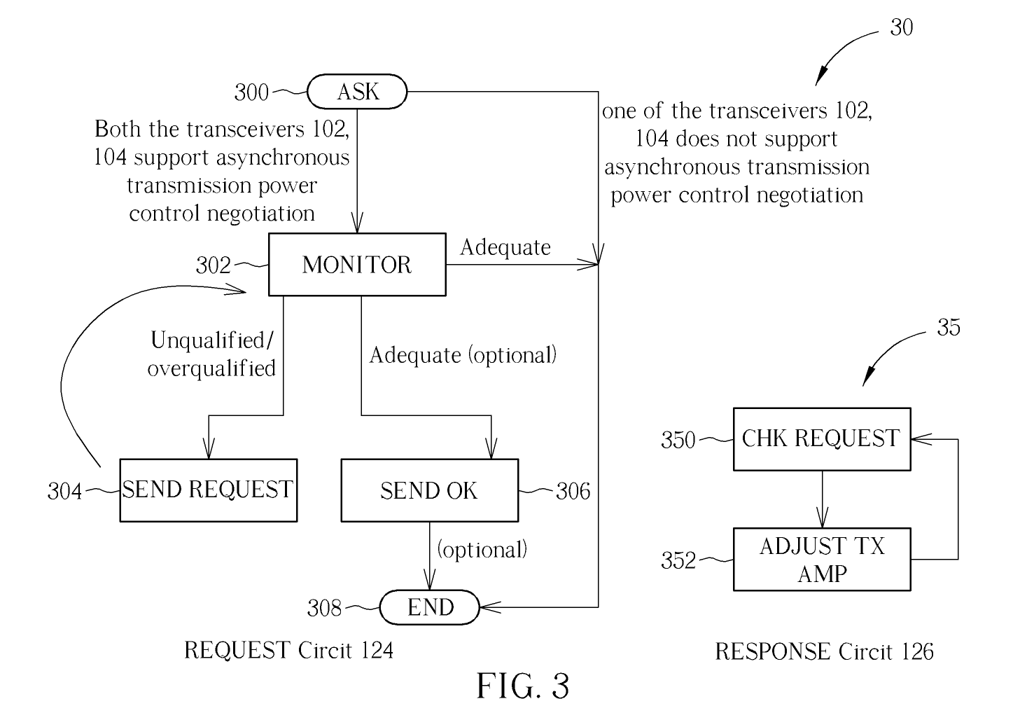

Moreover, please refer to FIG. 3-6, which are schematic diagrams of operations of the request circuits 122, 124, and the response circuits 126, 128 under different scenarios. As shown in FIG. 3, when the transceiver 104 intends to adjust transmission power of the transceiver 102 in an asynchronous transmission power adjustment, operations of the request circuit 124 of the transceiver 104 and the response circuit 126 of the transceiver 102 can be summarized into processes 30, 35 (operations of the request circuit 122 and the response circuits 128 are similar when the transceiver 102 intends to adjust transmission power of the transceiver 104). The process 30 includes the following steps:

Step 300: ASK: check if both the transceivers 102, 104 support asynchronous transmission power control negotiation. If yes, go to step 302; otherwise, go to step 308.

Step 302: MONITOR: analyze signal quality of the adjustment signals AS₁. If the adjustment signals AS₁ are unqualified or overqualified, go to step 304; if the adjustment signals AS₁ are adequate, optionally go to step 306 or go to step 308.

Step 304: SEND REQUEST: send the request message REQ₂ to ask the transceiver 102 to adjust transmission power.

Step 306: SEND OK: tell the transceiver 102 that the negotiation in the transceiver 104 will be finished via the end message END₁.

Step 308: END.

The process 35 includes the following steps:

Step 350: CHK REQUEST: check if the request message REQ₂ is received. If yes, go to step 352.

Step 352: ADJUST TX AMP: ask the TX 110 to adjust transmission power level according to the request message REQ₂.

According to the processes 30, 35, when the transceiver 104 intends to adjust transmission power of the transceiver 102 in an asynchronous transmission power adjustment, the request circuit 124 first checks if both the transceivers 102, 104 support asynchronous transmission power control negotiation. If one of the transceivers 102, 104 does not support asynchronous transmission power control negotiation, asynchronous transmission power control negotiation is not performed. If both the transceivers 102, 104 support asynchronous transmission power control negotiation, the request circuit 124 analyzes signal quality of the adjustment signals AS₁. If the adjustment signals AS₁ are unqualified or overqualified, the request circuit 124 sends the request message REQ₂ to ask the transceiver 102 to increase or decrease transmission power and thus the response circuit 126 can ask the TX 110 to increase or decrease transmission power according to the request message REQ₂. The request circuit 124 and the response circuit 126 repeat the above adjustment operations until the adjustment signals AS₁ are adequate. Then, the request circuit 124 can optionally tell the transceiver 102 that the negotiation in its part will be finished via the end message END₁ and then finish, or directly finish the negotiation in its part without telling the transceiver 102. Details of the processes 30, 35 can be derived by referring to FIG. 2A and related descriptions.

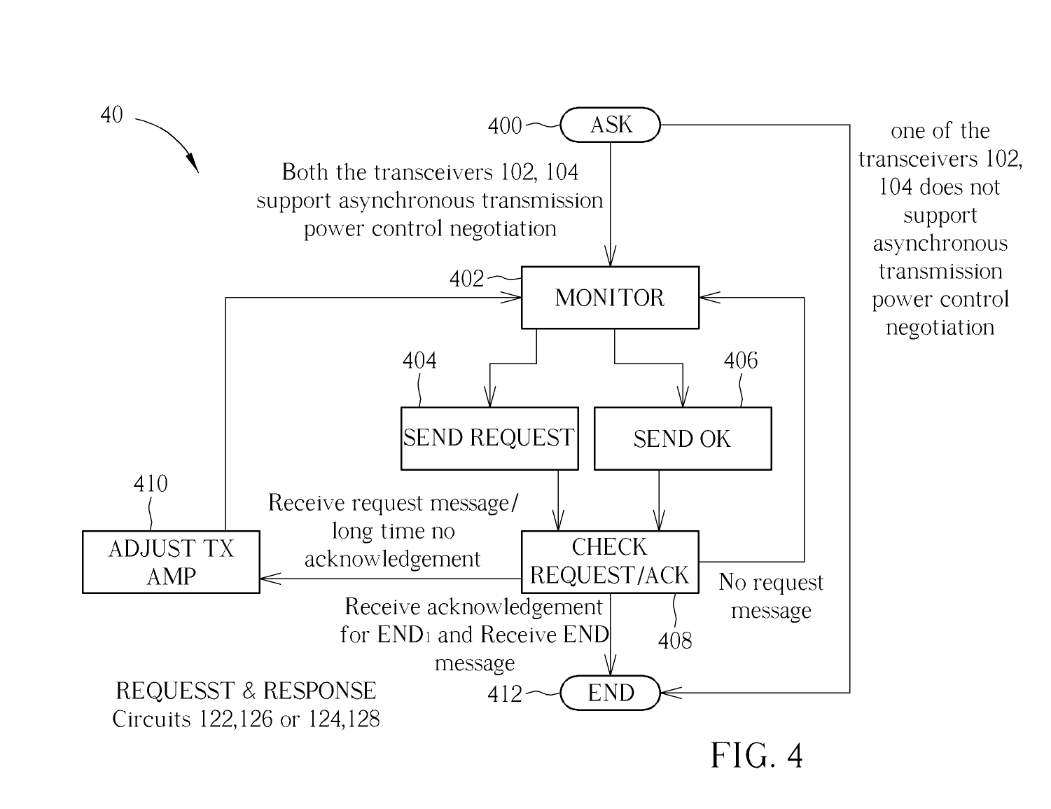

As shown in FIG. 4, when the transceivers 102, 104 intend to adjust transmission power of the transceivers 102, 104 in a synchronous transmission power adjustment, operations of the request circuit 124 and the response circuit 128 of the transceiver 104 can be summarized into processes 40. The process 40 includes the following steps:

Step 400: ASK: check if both the transceivers 102, 104 support synchronous transmission power control negotiation. If yes, go to step 402; otherwise, go to step 412.

Step 402: MONITOR: analyze signal quality of the adjustment signals AS₁. If the adjustment signals AS₁ are unqualified or overqualified, go to step 404; if the adjustment signals AS₁ are adequate, go to step 406.

Step 404: SEND REQUEST: send the request message REQ₂ to ask the transceiver 102 to adjust transmission power.

Step 406: SEND OK: tell the transceiver 102 that the negotiation in the transceiver 104 will be finished via the end message END₁.

Step 408: CHECK REQUEST/ACK: check if a request message for adjusting transmission power of the transceiver 104 is received and if an acknowledgement for the request message REQ₂ or an acknowledgement for the end message END₁ is received. If the request message is received or the acknowledgement for the request message REQ₂ is not received for a long time, go to step 410; if no request message is received, go to step 402; if the acknowledgement for the end message END₁ is received and an end message from the transceiver 102 is received, go to step 412.

Step 410: ADJUST TX AMP: ask the TX 112 to adjust transmission power level.

Step 412: END.

Noticeably, main differences between the process 40 and the processes 30, 35 are that the process 40 is applied in the transceiver 104 wherein the transceiver 104 adjusts transmission power of the transceiver 102 while being adjusted by the transceiver 102 which performs operations similar to the process 40 in a synchronous transmission power adjustment while the processes 30, 35 are applied in the transceivers, 102, 104 wherein the transceiver 104 adjusts transmission power of the transceiver 102 in a asynchronous transmission power adjustment. Under such a situation, when a transceiver receives a request message or an end message, the transceiver needs to reply an acknowledgement message, such that another transceiver can know the request message or the end message is actually received (signal quality of the request message or the end message may be too low for the transceiver). Besides, end messages are required for the transceivers 102, 104 to realize when to finish synchronous transmission power adjustment.

According to the process 40, when the transceiver 104 intends to adjust transmission power of the transceiver 102 in a synchronous transmission power adjustment, the request circuit 124 first checks if both the transceivers 102, 104 support synchronous transmission power control negotiation. If one of the transceivers 102, 104 does not support synchronous transmission power control negotiation, synchronous transmission power control negotiation is not performed. If both the transceivers 102, 104 support synchronous transmission power control negotiation, the request circuit 124 analyzes signal quality of the adjustment signals AS₁. If the adjustment signals AS₁ are unqualified or overqualified, the request circuit 124 sends the request message REQ₂ to ask the transceiver 102 to increase or decrease transmission power.

Meanwhile, if the request message sent by the transceiver 102 for adjusting transmission power of the transceiver 104 is received, the response circuit 128 asks the TX 112 to adjust transmission power level according to the request message. If no request message sent by the transceiver 102 for adjusting transmission power of the transceiver 104 is received, i.e. transmission power of the transceiver 104 may be adequate, the response circuit 128 keeps analyzes signal quality of the adjustment signals AS₁ to adjust transmission power of the transceiver 102. During adjusting transmission power of the transceiver 102, if the request circuit 124 sends the request message REQ₂ and an acknowledgement for the request message REQ₂ is not received for a long time, i.e. transmission power for sending the request message REQ₂ is too low, the response circuit 128 asks the TX 112 to increase transmission power level.

Then, by repeat the above operations, when the adjustment signals AS₁ are adequate, the request circuit 124 sends the end message END₁ to indicate the adjusted transmission power ATP₁ is adequate, and the response circuit 126 of the transceiver 102 replies an acknowledgement for the end message END₁. Under such a situation, if the acknowledgement for the end message END₁ is received and an end message sent by the transceiver 102 is received, i.e. transmission power of both the transceivers 102, 104 is adequate, the transceiver 104 finishes the synchronous transmission power adjustment of its part, i.e. transmitting following signals with adjusted transmission power, and finishing to indicate the transceiver 102 to adjust transmission power. Details of the process 40 can be derived by referring to FIG. 2A and related descriptions, and operations of the request circuit 122 and the response circuit 126 of the transceiver 102 are similar.

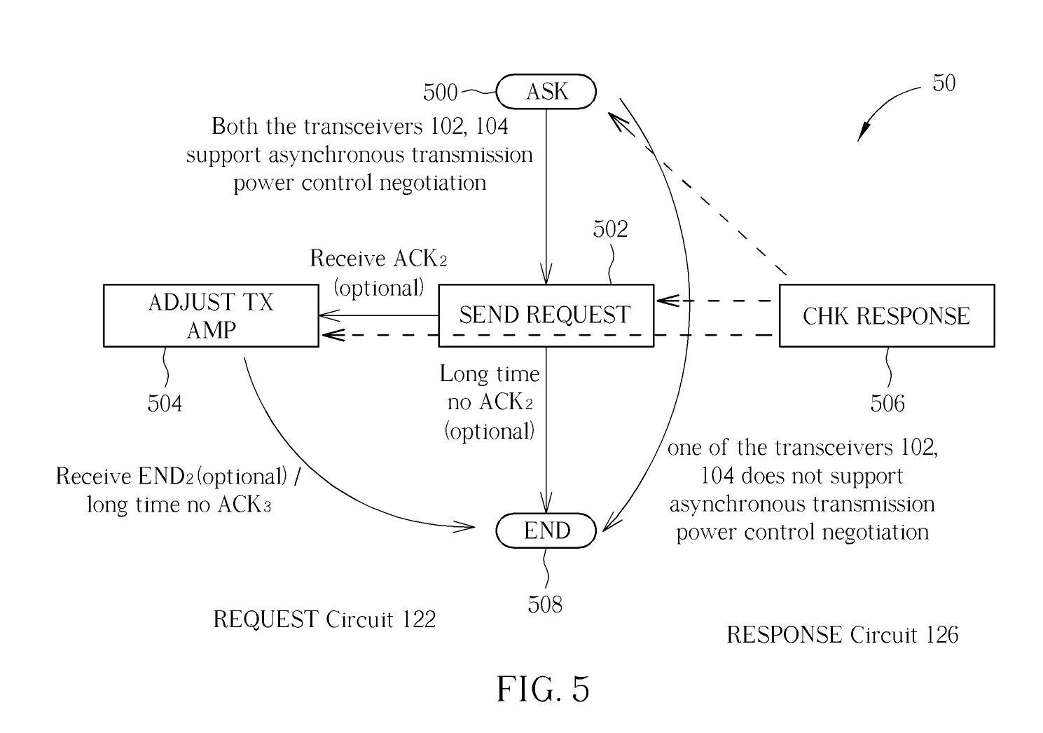

On the other hand, as shown in FIG. 5, when the transceiver 102 intends to adjust itself transmission power in an asynchronous transmission power adjustment, operations of the request circuit 122 and the response circuit 126 of the transceiver 102 can be summarized into process 50 (operations of the request circuit 124 and the response circuits 128 of the transceiver 104 are similar when the transceiver 102 intends to adjust itself transmission power). The process 50 includes the following steps:

Step 500: ASK: check if both the transceivers 102, 104 support asynchronous transmission power control negotiation. If yes, go to step 502; otherwise, go to step 508.

Step 502: SEND REQUEST: send the request message REQ₃ to indicate the transceiver 104 that the transceiver 102 starts to adjust itself transmission power. The acknowledgement ACK₂ for the request message REQ₃ is optional. With the implementation of ACK₂, go to step 504 if the acknowledgement ACK₂ for the request message REQ₃ is received. However, go to step 508 if the acknowledgement ACK₂ for the request message REQ₃ is not received for a long time; without the implementation of ACK₂, go the step 504 after sending request message REQ₃.

Step 504: ADJUST TX AMP: ask the TX 110 to adjust transmission power level. If the optional end message END₂ is received or the acknowledgement ACK₃ for the adjustment signals AS₁ is not received for a long time, go to step 508.

Step 506: CHK RESPONSE: check if response messages from the transceiver 102 are received.

Step 508: END.

According to the process 50, when the transceiver 102 intends to adjust itself transmission power in an asynchronous transmission power adjustment, the request circuit 122 first checks if both the transceivers 102, 104 support asynchronous transmission power control negotiation. If one of the transceivers 102, 104 does not support asynchronous transmission power control negotiation, asynchronous transmission power control negotiation is not performed. If both the transceivers 102, 104 support asynchronous transmission power control negotiation, the request circuit 122 sends the request message REQ₃ to indicate the transceiver 104 that the transceiver 102 starts to adjust itself transmission power while the transceiver 104 optionally replies the acknowledgement ACK₂ for the request message REQ₃. Under such a situation, if the transceiver 102 does not receive the acknowledgement ACK₂ for the request message REQ₃ for a long time, the request circuit 122 can optionally finish asynchronous transmission power adjustment.

On the other hand, if the transceiver 102 receives the acknowledgement ACK₂ for the request message REQ₃, the request circuit 122 asks the TX 110 to adjust transmission power level and the transceiver 102 transmits the adjustment signals AS₁ accordingly. Then, transceiver 104 replies the acknowledgement ACK₃ for the adjustment signals AS₁ if the adjustment signals AS₁ is qualified, and optionally replies the end message END₂ for the adjustment signals AS₁ if the adjustment signals AS₁ is adequate. Therefore, if the transceiver 102 optionally receives the end message END₂ indicating the adjusted transmission power ATP₁ is adequate, the request circuit 122 finishes transmission power adjustment of its part and transmits following signals with the adjusted transmission power ATP₁, or if the transceiver 102 does not receive the acknowledgement ACK₃ for the adjustment signals AS₁ for a long time, i.e. signal quality of the adjustment signals AS₁ is unqualified and thus the transceiver 104 does not respond the acknowledgement ACK₃ for the adjustment signals AS₁, the transceiver 102 finishes transmission power adjustment of its part and transmits following signals with the default transmission power or the lowest adjusted transmission power ATP₁ corresponding to the last received acknowledgement ACK₃. During the above operations, the response circuit 126 keeps checking if response messages (e.g. response for ASK, the acknowledgement ACK₂ for the request message REQ₃ or the acknowledgement ACK₃ for the adjustment signals AS₁) are received, and informs the request circuit 122 to operate correspondingly. Details of the process 50 can be derived by referring to FIG. 2B and related descriptions.

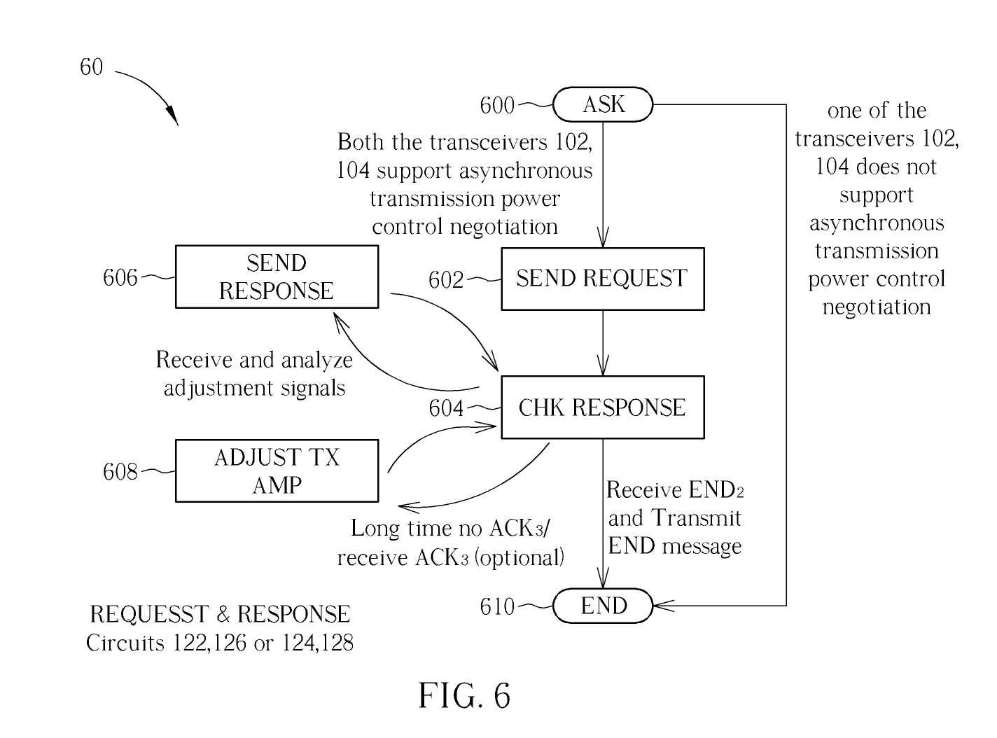

As shown in FIG. 6, when the transceivers 102, 104 intend to adjust themselves transmission power in a synchronous transmission power adjustment, operations of the request circuit 122 and the response circuit 126 of the transceiver 104 can be summarized into processes 60. The process 60 includes the following steps:

Step 600: ASK: check if both the transceivers 102, 104 support synchronous transmission power control negotiation. If yes, go to step 602; otherwise, go to step 610.

Step 602: SEND REQUEST: send the request message REQ₃ to indicate the transceiver 104 that the transceiver 102 starts to adjust itself transmission power.

Step 604: CHK RESPONSE: check if response messages or adjustment signals from the transceiver 102 are received. If adjustment signals from the transceiver 102 are received, analyze the adjustment signals and go to step 606; if the acknowledgement ACK₃ for the adjustment signals AS₁ is not received for a long time or the acknowledgement ACK₃ for the adjustment signals AS₁ is optionally received, go to step 608; if the end message END₂ is received and an END message is transmitted to the transceiver 102, go to step 610.

Step 606: SEND RESPONSE: send an acknowledgement for the adjustment signals to the transceiver 104 if the adjustment signals from the transceiver 104 are qualified and send an end message for the adjustment signals to the transceiver 104 if the adjustment signals from the transceiver 104 are adequate. go to step 604.

Step 608: ADJUST TX AMP: ask the TX 110 to adjust transmission power level and go to step 604.

Step 610: END.

Noticeably, main differences between the process 60 and the process 50 are that the process 60 is applied in the transceiver 102 wherein the transceiver 102 adjusts itself transmission power while the transceiver 104 performs operations similar to the process 60 to adjust itself transmission power in a synchronous transmission power adjustment while the process 50 is applied in the transceiver 102 wherein the transceiver 103 adjusts itself transmission power in a asynchronous transmission power adjustment. Under such a situation, when a transceiver receives adjustment signals, the transceiver needs to reply an acknowledgement message or an end message, such that another transceiver can know the adjustment signals is actually received (signal quality of the adjustment signals may be too low for the transceiver). Besides, end messages are required for the transceivers 102, 104 to realize when to finish synchronous transmission power adjustment.

According to the process 60, when the transceiver 102 intends to adjust itself transmission power in a synchronous transmission power adjustment, the request circuit 122 first checks if both the transceivers 102, 104 support synchronous transmission power control negotiation. If one of the transceivers 102, 104 does not support synchronous transmission power control negotiation, synchronous transmission power control negotiation is not performed. If both the transceivers 102, 104 support synchronous transmission power control negotiation, the request circuit 122 send the request message REQ₃ to indicate the transceiver 104 that the transceiver 102 starts to adjust itself transmission power and the transceiver 104 can optionally reply the acknowledgement ACK₂ for the request message REQ₃. Then, the request circuit 122 asks the TX 110 to adjust transmission power level and the transceiver 102 transmits the adjustment signals AS₁ accordingly. Afterwards, transceiver 104 optionally replies the acknowledgement ACK₃ for the adjustment signals AS₁ if the adjustment signals AS₁ is qualified, and replies the end message END₂ for the adjustment signals AS₁ if the adjustment signals AS₁ is adequate.

Meanwhile, since the transceiver 104 can simultaneously send adjustment signals with adjusted transmission power, if adjustment signals from the transceiver 104 are received, the response circuit 126 analyzes the adjustment signals and sends an acknowledgement for the adjustment signals to the transceiver 104 if the adjustment signals from the transceiver 104 are qualified, and send an end message for the adjustment signals to the transceiver 104 if the adjustment signals from the transceiver 104 are adequate.

On the other hand, if the transceiver 102 optionally receives the acknowledgement ACK₃ for the previous adjustment signals AS₁, in order to reduce power consumption at most, the transceiver 102 can further lower the adjusted transmission power ATP₁ to transmit the adjustment signals AS₁; if the transceiver 102 does not receive the acknowledgement ACK₃ for the adjustment signals AS₁ for a long time, i.e. signal quality of the adjustment signals AS₁ is unqualified and thus the transceiver 104 does not respond the acknowledgement ACK₃ for the adjustment signals AS₁, the transceiver 102 could transmit following signals with the default transmission power or the lowest adjusted transmission power ATP₁ corresponding to the last received acknowledgement ACK₃; if the transceiver 102 has received the end message END₂ indicating the adjusted transmission power ATP₁ is adequate and has transmitted an end message for the adjustment signals of transceiver 104, the request circuit 122 finishes transmission power adjustment of its part and transmits following signals with the adjusted transmission power ATP₁. Details of the process 60 can be derived by referring to FIG. 2B and related descriptions.

In the prior art, since the local device estimates the cable length by itself, the estimated cable length may not be reliable due to unideal factors, and since the adjusted transmission amplitude is not confirmed by the remote device, there is still an interoperability issue. In comparison, in the present invention, one transceiver can analyze adjustment signals with adjusted transmission power and send messages for another transceiver to adjust the adjusted transmission power, to reduce unnecessary power consumption as most in a short cable case and avoid an interoperability issue in a long cable case. Besides, the present invention can perform synchronous transmission power adjustment, to reduce adjustment time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmission power control negotiation method for a communication system, the communication system comprising a first transceiver and a second transceiver, the transmission power control negotiation method comprising:
the first transceiver transmitting a first adjustment signal to the second transceiver with a first transmission power;
the second transceiver analyzing the first adjustment signal and sending a negotiation message to the first transceiver to adjust the first transmission power; and
in response to the negotiation message, the first transceiver transmitting signals with the adjusted first transmission power.

2. The transmission power control negotiation method of claim 1, wherein the second transceiver sends a first request message to the first transceiver to start adjusting transmission power.

3. The transmission power control negotiation method of claim 2, wherein in response to the first request message, the first transceiver replies a first acknowledgement (ACK) and transmits the first adjustment signal.

4. The transmission power control negotiation method of claim 2, wherein the second transceiver sends a second request message to the first transceiver to increase or decrease the first transmission power.

5. The transmission power control negotiation method of claim 2, wherein the second transceiver sends a first end message to indicate the first transmission power is adequate.

6. The transmission power control negotiation method of claim 1, wherein the first transceiver sends a third request message to the second transceiver when the first transceiver starts to adjust the first transmission power.

7. The transmission power control negotiation method of claim 6, wherein the second transceiver replies a second ACK in response to the third request message, and the first transceiver transmits the first adjustment signal after receiving the second ACK.

8. The transmission power control negotiation method of claim 6, wherein the second transceiver sends a third ACK in response to the first adjustment signal, or sends a second end message when the first transmission power is adequate.

9. The transmission power control negotiation method of claim 8, wherein if the first transceiver does not receive the third ACK for a predetermined time period, the first transceiver adjusts the first transmission power to a default transmission power or a second transmission power with which the first transceiver transmits a second adjustment signal and receives a fourth ACK for the second adjustment signal.

10. The transmission power control negotiation method of claim 1 further comprising:
the second transceiver transmitting a third adjustment signal to the first transceiver with a third transmission power;
the first transceiver analyzing the third adjustment signal and sending a negotiation message for the second transceiver to adjust the third transmission power; and
the second transceiver transmitting signals with the third transmission power.

11. The transmission power control negotiation method of claim 10, wherein the second transceiver sends a fourth request message to the first transceiver to start adjusting transmission power; and the first transceiver sends a fifth request message to the second transceiver to start adjusting transmission power.

12. The transmission power control negotiation method of claim 11, wherein the first transceiver replies a fifth ACK in response to the fourth request message and transmits the first adjustment signal after receiving the fourth request message; and the second transceiver replies a sixth ACK for the fifth request message and transmits the third adjustment signal after receiving the fifth request message.

13. The transmission power control negotiation method of claim 11, wherein after analyzing the first adjustment signal, the second transceiver sends a sixth request message to the first transceiver to increase or decrease the first transmission power; and after analyzing the third adjustment signal, the first transceiver sends a seventh request message to the second transceiver to increase or decrease the third transmission power.

14. The transmission power control negotiation method of claim 11, wherein after analyzing the first adjustment signal, the second transceiver sends a third end message to indicate the first transmission power is adequate; and after analyzing the third adjustment signal, the first transceiver sends a fourth end message to indicate the third transmission power is adequate.

15. The transmission power control negotiation method of claim 14, wherein after receiving the third end message, the first transceiver replies a seventh ACK in response to the third end message and transmitting signals with the first transmission power; and after receiving the fourth end message, the second transceiver replies an eighth ACK in response to the fourth end message and transmitting signals with the third transmission power.

16. The transmission power control negotiation method of claim 10, wherein the first transceiver sends an eighth request message to the second transceiver when the first transceiver starts to adjust transmission power; and the second transceiver sends an ninth request message to the first transceiver when the second transceiver starts to adjust transmission power.

17. The transmission power control negotiation method of claim 16, wherein the second transceiver replies a ninth ACK in response to the eighth request message, and the first transceiver transmits the first adjustment signal after receiving the ninth ACK; and the first transceiver replies a tenth ACK in response to the ninth request message, and the second transceiver transmits the third adjustment signal after receiving the tenth ACK.

18. The transmission power control negotiation method of claim 16, wherein after analyzing the first adjustment signal, the second transceiver sends a eleventh ACK in response to the first adjustment signal, or sends an fifth end message to indicate the first transmission power is adequate; and after analyzing the third adjustment signal, the first transceiver sends a twelfth ACK in response to the third adjustment signal, or sends an sixth end message to indicate the third transmission power is adequate.

19. The transmission power control negotiation method of claim 18, wherein if the first transceiver does not receive the eleventh ACK for a predetermined time period or receives the eleventh ACK, the first transceiver adjusts the first transmission power; and if the second transceiver does not receive the twelfth ACK for a predetermined time period or receives the twelfth ACK, the second transceiver adjusts the third transmission power.

20. The transmission power control negotiation method of claim 18, wherein if the first transceiver receives the fifth end message, the first transceiver stops adjusting transmission power; and if the second transceiver receives the sixth end message, the second transceiver stops adjusting transmission power.

21. The transmission power control negotiation method of claim 18, wherein the communication system is an Ethernet communication system.

22. A wireless communication system, comprising:
a first transceiver, comprising:
a first transmission power control circuit, comprising a first request circuit and a first response circuit; and
a second transceiver, comprising:
a second transmission power control circuit, comprising a second request circuit and a second response circuit;
wherein the first transceiver and the second transceiver perform the transmission power control negotiation method of claim 1.
